(19) United States
(12) Patent Application Publication
(10) Pub. No.: US 2003/0197361 A1
(43) Pub. Date: Oct. 23, 2003

(54) Wheeled vehicle with a steering rear handle

(76) Inventor: Tse-Tsung Chang, Kaohsiung Hsien (TW)

Correspondence Address: MCNEES, WALLACE & NURICK, 100 PINE STREET, P.O. BOX 1166, HARRISBURG, PA, 17108-1166, US

(21) Appl. No.: 10/400,262

(22) Filed: Mar. 27, 2003

(30) Foreign Application Priority Data
Apr. 18, 2002 (TW) 091205207

(51) Int. Cl. B62K 21/00

(52) U.S. Cl. 280/774

(57) ABSTRACT

A wheeled vehicle includes a front driven shaft mounted to and rotatable relative to a front frame portion, a front wheel body mounted to rotate with the front driven shaft, a rear driving shaft mounted to and rotatable relative to a rear frame portion and having an upper driving end to be operated manually, and a force transmitting mechanism including front and rear rotary members which are respectively coupled to the front driven and rear driving shafts, and a transmitting member connected to the front and rear rotary members so as to transmit rotational movement of the rear rotary member, which is initiated manually by the rear driving shaft, to drive the front rotary member and the front driven shaft to rotate, thereby resulting in a swiveling movement of the front wheel body.

### CROSS-REFERENCE TO RELATED APPLICATION

This application claims priority of Taiwanese Application No. 091205207, filed on Apr. 18, 2002.

### BACKGROUND OF THE INVENTION

1. Field of the Invention

This invention relates to a wheeled vehicle, more particularly to a wheeled vehicle with a steering rear handle to steer a front wheel for swiveling the vehicle.

2. Description of the Related Art

A conventional wheeled vehicle for carrying articles generally has a rear handle shaft for pushing the vehicle along and controlling the movement direction of the vehicle. To change the movement direction of the vehicle, the user needs to apply a relatively large force to the rear handle shaft, which is inconvenient.

A conventional baby carriage has a steering device mounted on a rear frame body to assist control of the movement direction of the carriage. However, as the device projects and is exposed from the rear frame body, it may cause injury to the user.

### SUMMARY OF THE INVENTION

The object of the present invention is to provide a wheeled vehicle which has a steering mechanism adapted for controlling the movement direction of the vehicle and concealed in a vehicle frame so as to be operated safely.

According to this invention, the wheeled device includes a mounting frame having front and rear frame portions opposite to each other in a longitudinal direction. A front driven shaft is mounted to and is rotatable relative to the front frame portion about a front swivel axis in an upright direction transverse to the longitudinal direction, and has a lower driven end and an upper driven end which extends upwardly from the lower driven end along the front swivel axis. A front wheel body is mounted to be rotated with the lower driven end about the rear swivel axis, and is adapted to be rollable on the ground. A rear driving shaft is mounted to and is rotatable relative to the rear frame portion about a rear swivel axis in the upright direction, and has a lower driving end and an upper driving end which extends upwardly from the lower driving end to be operated manually. A force transmitting mechanism has front and rear rotary members which are coupled to and which are rotated with the front driven and rear driving shafts about the front and rear swivel axes, respectively, and a transmitting member which is disposed to couple the front rotary member with the rear rotary member such that when the upper driving end is operated manually, rotational movement of the rear rotary member about the rear swivel axis is transmitted to drive the front rotary member and the front driven shaft to rotate about the front swivel axis, thereby resulting in a swiveling movement of the front wheel body.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a fragmentary side view of the first preferred embodiment of a wheeled vehicle according to this invention;

FIG. 2 is a partially sectioned view showing a portion of the first preferred embodiment;

FIG. 3 is a partially sectioned view similar to FIG. 2 but taken from another angle;

FIG. 4 is a partially sectioned view of a portion of the second preferred embodiment of a wheeled vehicle according to this invention;

FIG. 5 is a partially sectioned view similar to FIG. 4 but taken from another angle;

FIG. 6 is a partially sectioned view of a portion of the third preferred embodiment of a wheeled vehicle according to this invention; and

FIG. 7 is a partially sectioned view similar to FIG. 6 but taken from another angle.

### DETAILED DESCRIPTION OF THE PREFERRED EMBODIMENTS

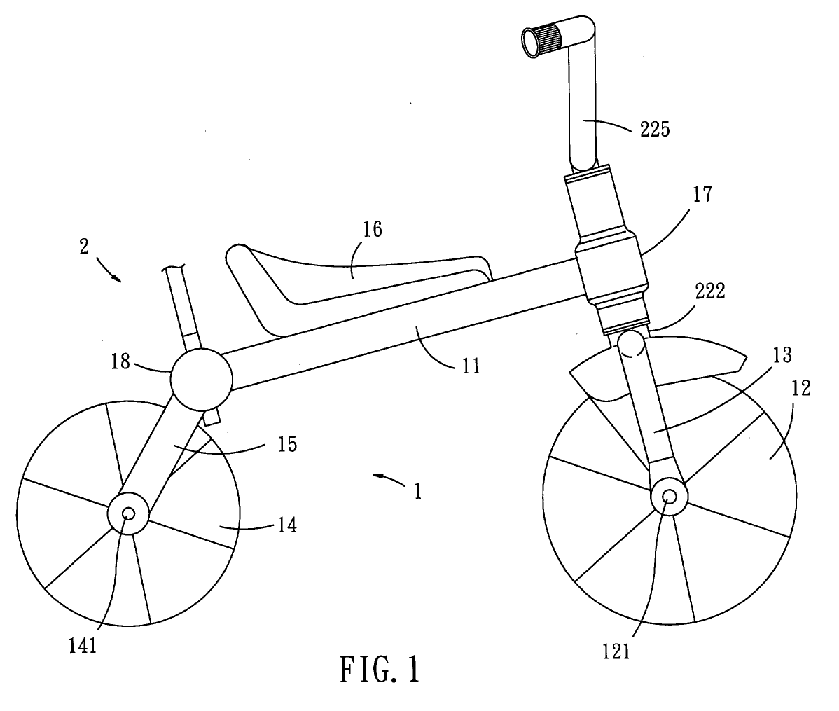

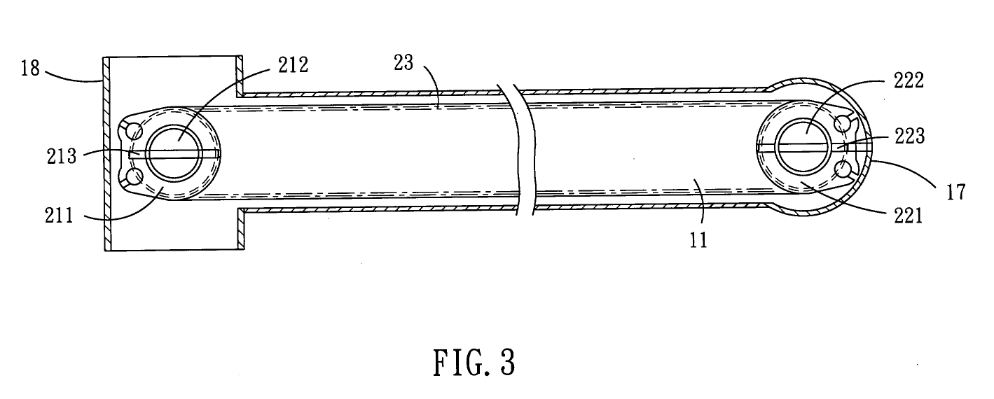

Referring to FIGS. 1 to 3, the first preferred embodiment of a wheeled vehicle according to the present invention is shown to be adapted to carry articles and a child, and is shown to comprise a vehicle mounting frame 1 and a steering mechanism 2 mounted on the vehicle mounting frame 1.

The vehicle mounting frame 1 includes tubular front and rear frame portions 17,18 which are opposite to each other in a longitudinal direction and which respectively have front and rear inner peripheral walls that confine front and rear accommodation spaces, respectively, and a tubular intermediate segment 11 which is interposed between the front and rear frame portions 17,18 and which defines an accommodation chamber to communicate the front and rear accommodation spaces. A seat member 16 is mounted on the intermediate segment 11. Front and rear wheel bodies respectively include front and rear fork members 13,15 which are respectively pivoted to the front and rear frame portions 17,18 in a known manner, and front and rear wheel axles 121,141 which are respectively connected to lower fork ends of the front and rear fork members 13,15 and which are respectively provided with front and rear wheels 12,14 to be rollable on the ground.

The steering mechanism 2 includes a front driven shaft 222, a rear driving shaft 212 and a force transmitting mechanism.

The front driven shaft 222 is received in and is rotatable relative to the front accommodation space of the front frame portion 17 about a front swivel axis in an upright direction transverse to the longitudinal direction, and has a lower driven end which is connected to an upper fork end of the front fork member 13 so as to rotate with the front wheel body, and an upper driven end which extends upwardly from the lower driven end along the front swivel axis. A front stabilizing member 224 is mounted securely on the front inner peripheral wall of the front frame portion 17, and is sleeved on the lower driven end of the front driven shaft 222 for stabilizing rotation of the latter about the front swivel axis.

The rear driving shaft 212 is received in and is rotatable relative to the rear accommodation space of the rear frame portion 18 about a rear swivel axis in the upright direction, and has a lower driving end and an upper driving end which extends upwardly from the lower driving end to project outwardly of the rear frame portion 18 so as to be operated manually. A rear stabilizing member 214 is mounted securely to the rear frame portion 18, and is sleeved on the lower driving end of the rear driving shaft 212 for stabilizing rotation of the latter about the rear swivel axis.

The force transmitting mechanism includes front and rear rotary members 221,211 and a transmitting member 23 which are received in the front and rear accommodation spaces of the front and rear frame portions 17,18 and the accommodation chamber of the intermediate segment 11, respectively.

The front and rear rotary members 221,211 are in form of circular rings, and respectively have through holes 2210,2110 extending along the front and rear swivel axes such that the front and rear rotary members 221,211 are respectively sleeved on the front driven shaft 222 and the rear driving shaft 212. In addition, a front pin 223 is disposed to pass through the front rotary member 221 and the front driven shaft 222 in a direction radial to the front swivel axis, thereby securing the front rotary member 221 to the front driven shaft 222 for co-rotation therewith. Similarly, a rear pin 213 is disposed to pass through the rear rotary member 211 and the rear driving shaft 212 in a direction radial to the rear swivel axis, thereby securing the rear rotary member 211 to the rear driving shaft 212 for co-rotation therewith.

In this embodiment, the front and rear rotary members 221,211 respectively have outer peripheral walls which surround the front and rear swivel axes, respectively. The transmitting member 23 is an endless tensioned band, such as a belt or a steel wire, and is trained on the outer peripheral walls of the front and rear rotary members 221,211 to synchronize rotations of the front and rear rotary members 221,211.

As such, when the rear driving shaft 212 is rotated about the rear swivel axis, a rotational movement of the rear rotary member 211 about the rear swivel axis is transmitted to drive the front rotary member 221 and the front driven shaft 222 to rotate about the front swivel axis, thereby resulting in a swiveling movement of the front wheel body.

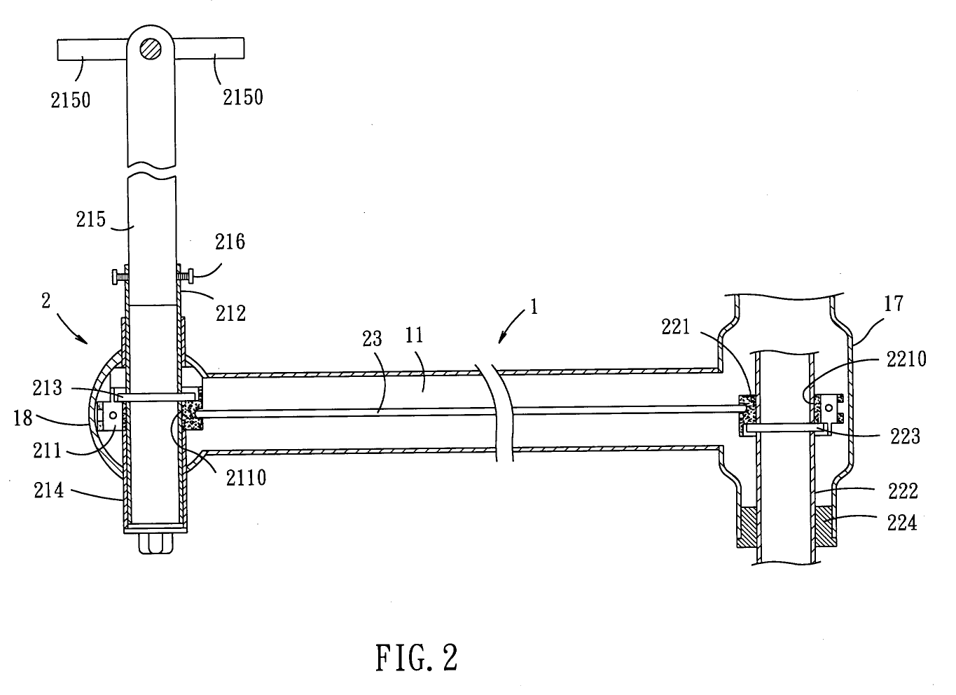

Preferably, as shown in FIG. 2, a rear handle 215 is connected detachably to the upper driving end of the rear driving shaft 212 by means of screw fasteners 216, and has two handgrip portions 2150 at an upper end thereof for facilitating operation of the rear driving shaft 212. The rear handle 215 is detachable from the rear driving shaft 212 to facilitate transportation and storage.

Preferably, as shown in FIG. 1, a front handle 225 is connected to the upper driven end of the front driven shaft 222 for gripping by a child sitting on the seat 16.

As illustrated, when the operator grips the handgrip portions 2150 and rotates the rear driving shaft 212 and the rear rotary member 211 about the rear swivel axis, the front rotary member 221 will rotate synchronously about the front swivel axis through the transmitting member 23 so as to drive the front driven shaft 222 to rotate about the front swivel axis, thereby resulting in a swiveling movement of the front wheel body, i.e. the front fork member 13, the front wheel axle 121 and the front wheel 12. Thus, change of the direction of the vehicle can be easily achieved. Furthermore, the steering mechanism is accommodated in the vehicle mounting frame 1, with only the upper driving end of the rear driving shaft 212 projecting therefrom for manipulation, thereby minimizing the risk of injury to the operator and the child sitting on the seat member 16.

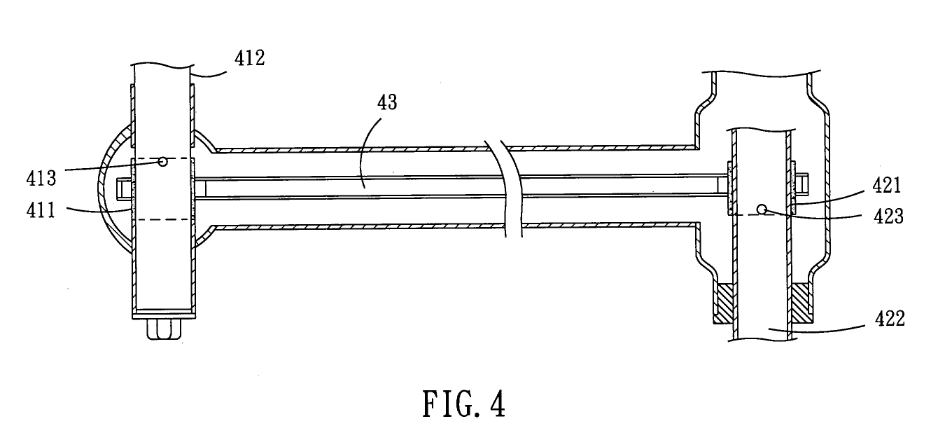

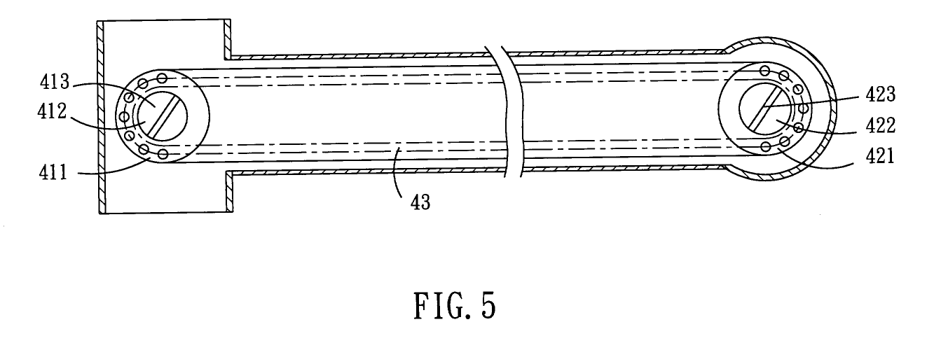

Referring to FIGS. 4 and 5, the second preferred embodiment of a wheeled vehicle is shown to be similar to the first preferred embodiment in construction, and comprises a front driven shaft 422, a rear driving shaft 412, and a force transmitting mechanism. The force transmitting mechanism includes right and left rotary members 421,411 which are sprocket wheels and which are sleeved securely and respectively on the front driven and rear driving shafts 422,412 by means of pins 423,413, and a transmitting member 43 which is a chain and which is trained on the sprocket wheels.

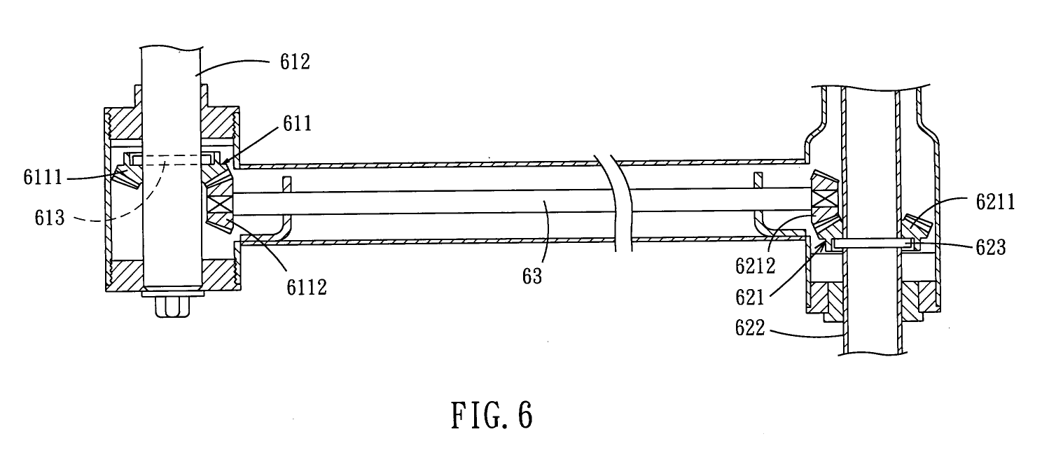

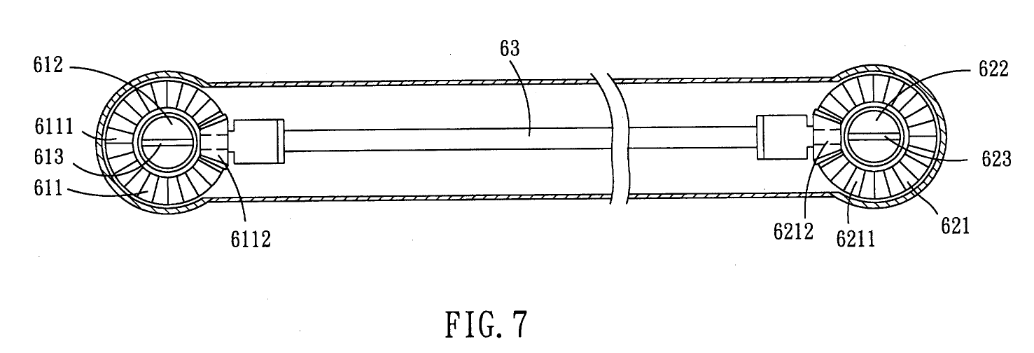

Referring to FIGS. 6 and 7, the third preferred embodiment of a wheeled vehicle is shown to be similar to the first preferred embodiment in construction, and comprises a front driven shaft 622, a rear driving shaft 612, and a force transmitting mechanism. The force transmitting mechanism includes right and left rotary members 621,611, each of which is a bevel gearing unit, and a transmitting member 63. The bevel gearing unit includes a first gear 6211,6111 which is sleeved securely on a respective one of the front driven and rear driving shafts 422,412 by means of pins 623,613 and which is rotated about a respective one of the front and rear swivel axes, and a second gear 6212,6112 which mates with the first gear 6211,6111 and which is rotated about a rotating axis in the longitudinal direction. The transmitting member 63 is a transmitting shaft, and is coupled to the second gears 6212,6112 so as to be rotated about the rotating axis.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A wheeled vehicle comprising:
a mounting frame including front and rear frame portions opposite to each other in a longitudinal direction;
a front driven shaft mounted to and rotatable relative to said front frame portion about a front swivel axis in an upright direction transverse to the longitudinal direction, and having a lower driven end and an upper driven end which extends upwardly from said lower driven end along the front swivel axis;
a front wheel body mounted to be rotated with said lower driven end about the rear swivel axis, and adapted to be rollable on the ground;
a rear driving shaft mounted to and rotatable relative to said rear frame portion about a rear swivel axis in the upright direction, and having a lower driving end and an upper driving end which extends upwardly from said lower driving end to be operated manually; and
a force transmitting mechanism having front and rear rotary members which are coupled to and which are rotated with said front driven and rear driving shafts about the front and rear swivel axes, respectively, and a transmitting member disposed to couple said front rotary member with said rear rotary member such that rotational movement of said rear rotary member about the rear swivel axis, which is initiated manually through said upper driving end of said rear driving shaft, is transmitted to drive said front rotary member and said front driven shaft to rotate about the front swivel axis, thereby resulting in a swiveling movement of said front wheel body.

2. The wheeled vehicle of claim 1, wherein said front and rear frame portions respectively have front and rear inner peripheral walls which confine front and rear accommodation spaces, respectively, and which surround said front driven shaft and said rear driving shaft, respectively.

3. The wheeled vehicle of claim 2, wherein said mounting frame further includes a tubular intermediate segment which defines an accommodation chamber that receives said transmitting member, and which is interposed between said front and rear frame portions such that said accommodation chamber communicates said front accommodation space with said rear accommodation space.

4. The wheeled vehicle of claim 3, wherein said front and rear rotary members are respectively sleeved on said front driven shaft and said rear driving shaft, said wheeled vehicle further comprising a front pin which is disposed to pass through said front rotary member and said front driven shaft in a direction radial to the front swivel axis, thereby securing said front rotary member to said. front driven shaft, and a rear pin which is disposed to pass through said rear rotary member and said rear driving shaft in a direction radial to the rear swivel axis, thereby securing said rear rotary member to said rear driving shaft.

5. The wheeled vehicle of claim 4, wherein said front and rear rotary members respectively have outer peripheral walls which surround the front and rear swivel axes, respectively, said transmitting member being an endless tensioned band which is trained on said outer peripheral walls of said front and rear rotary members to synchronize rotation of said front and rear rotary members.

6. The wheeled vehicle of claim 5, wherein said front and rear rotary members are sprocket wheels, and said transmitting member is a chain which is trained on said sprocket wheels.

7. The wheeled vehicle of claim 4, wherein each of said front and rear rotary members is a bevel gearing unit which includes a first gear that is rotated about a respective one of the front and rear swivel axes, and a second gear that mates with said first gear and that is rotated about a rotating axis in the longitudinal direction, said transmitting member being a transmitting shaft which is coupled to said second gears of said front and rear rotary members and which is rotated about the rotating axis.

8. The wheeled vehicle of claim 3, further comprising front and rear stabilizing members which are respectively mounted to said front and rear frame portions, and which are sleeved on said lower driven end of said front driven shaft and said lower driving end of said rear driving shaft for stabilizing rotations of said front driven and rear driving shafts about the front and rear swivel axes, respectively.

9. The wheeled vehicle of claim 3, further comprising a rear handle which is connected detachably to said upper driving end of said front driving shaft and which has two handgrip portions.

10. The wheeled vehicle of claim 3, further comprising a front handle which is connected to said upper driven end of said front driven shaft.

11. The wheeled vehicle of claim 1, wherein said front wheel body includes a fork member which has a lower fork end and an upper fork end that is connected to said lower driven end of said front driven shaft, and a wheel axle which is provided with a wheel, and which is connected to said lower fork end of said fork member.
